(19) United States
(12) Patent Application Publication
(10) Pub. No.: US 2026/0113699 A1
(43) Pub. Date: Apr. 23, 2026

(54) SELECTION OF SUBSCRIPTION PROFILES

(71) Applicant: Telefonaktiebolaget LM Ericsson (publ), Stockholm (SE)

(72) Inventors: Giuseppe BURGARELLA, Dublin, CA (US); Wassim Michel HADDAD, San Jose, CA (US)

(73) Assignee: Telefonaktiebolaget LM Ericsson (publ), Stockholm (SE)

(21) Appl. No.: 19/117,266

(22) PCT Filed: Mar. 7, 2023
(86) PCT No.: PCT/IB2023/052166

§ 371 Date: Mar. 31, 2025

Related U.S. Application Data
(60) Provisional application No. 63/414,078, filed on Oct. 7, 2022.

(51) Int. Cl. H04W 48/18; H04W 8/20; H04W 12/63; H04W 64/00; H04W 88/06

(52) U.S. Cl. CPC H04W 48/18; H04W 8/205; H04W 12/63; H04W 64/006; H04W 88/06

(57) ABSTRACT

A method (500) performed by a communication device comprising a secure element storing a set of available profiles. The set of available profiles comprises a first profile and a second profile. The method includes obtaining a profile policy. The method also includes, based on the profile policy, determining a preferred profile from among the available profiles, wherein the preferred profile identifies a preferred network. The method also includes after determining the preferred profile, determining whether the preferred network is available. The method further includes, i) after determining that the preferred network is available, enabling the preferred profile or ii) after determining that the preferred network is not available, disabling the preferred profile.

### TECHNICAL FIELD

Disclosed are embodiments related to selection of subscription profiles.

### BACKGROUND

A subscription profile (or “profile” for short), such as, for example, a Subscriber Identity Module (SIM) profile, is a collection of data (a.k.a., data package) that contains, among other items, subscription credentials, which include a subscription identifier, such as, for example, a third generation partnership project (3GPP) Subscriber Permanent Identifier (SUPI) or an International Mobile Subscriber Identity (IMSI). The profile may also include another unique identifier, such as an Integrated Circuit Card Identification Number (ICCID).

Generally, a communication device that seeks to gain access to a mobile network needs to have at least one subscriber profile provided by the operator that manages the mobile network to enable the mobile network to determine whether the device is authorized to access the network.

Traditionally, to configure a communication device to be able to access a mobile network, an owner of the communication device enters into a contract with the mobile network operator (MNO) that operates the network and receives in return a SIM card storing a SIM profile containing a subscription identifier. A SIM card is a type of integrated circuit card (ICC)

The SIM card is then physically inserted into a slot in the communication device to allow the device to connect to the MNO's network. If the owner of the device switches their contract to a different MNO, the owner would receive a new SIM card from the new MNO with different subscription credentials and physically replace their old SIM card with the new one.

Thanks to the advent of remote SIM profile provisioning, users no longer need to insert or swap out physical SIM cards. Instead, a Universal Integrated Circuit Card (UICC) can be used, such as, for example, an embedded UICC (eUICC), an integrated UICC (iUICC), or other secure element. Unlike a SIM card that conventionally stores only a single subscriber profile, a UICC can store multiple subscriber profiles.

FIG. 1 illustrates a conventional system 100 for enabling a communication device 102 to obtain and store multiple SIM profiles. The communication device 102 may be any type of device that has the capability to connect to a wireless network. For example, the communication device may be a mobile phone, a smart watch, laptop, a tablet, a cellular Internet-of-Things (cIoT) device, a smart appliance, a smart sensor, etc.

As shown in FIG. 1, communication device 102 includes a conventional Local Profile Assistant (LPA) 104 running within the operating system 106 of device 102. LPA 104 allows the device 102 to interface with SM-DP+ servers.

The LPA 104 may include an interface functionality allowing an end user 118 to interact with the LPA 104. The end user 118 may use the LPA 104 to activate a selected profile to connect to a wireless network provided by a mobile network operator 120.

The LPA 104 may also include discovery functionality that allows the LPA 104 to connect to an Subscription Manager-Discovery Server (SM-DS) 114. The SM-DS 114 may include a root address of a Subscription Manager-Data Preparation+ (SM-DP+) 116. The LPA 104 may receive the root address from the SM-DS 114. The LPA 104 may use the root address to connect to the SM-DP+ 116. The SM-DP+ 116 is responsible for storing, creating, and deleting profiles tied to a mobile network operator 120.

The LPA 104 may also include download functionality to enable the LPA service 108 to receive profiles. The LPA service 108 may connect to the SM-DP+ 116 via the LPA 104 in order to download relevant profiles that are stored within the SM-DP+ 116. Once the LPA service 108 receives a profile from the SM-DP+ 116, LPA service 108 stores the profile in a storage unit 110 of secure element 112. The secure element 112 may be a UICC (e.g., an eUICC).

Given today's “work form anywhere” work environment, employers have a challenge to create proper “corporate network” and to manage their employees' communication devices. To this end, corporate information technology (IT) departments employ one (or several) Mobile Device Management (MDM) systems that are available in the market to manage the communication devices. Example MDM systems include Microsoft Intune, AirWatch, Jamf, Citrix, etc. An MDM system can be hosted in the “cloud” or in-house or even offered as a service

### SUMMARY

Certain challenges presently exist. For example, current communication devices supporting multiple SIM profiles allow for the user of the device to select a profile and enable the selected profile. Corporate IT departments, however, do not want to give their employees ability to manually select whatever mobile network they prefer; instead, the IT departments want the system itself to select the best SIM profile (and, hence, the best network provider). As an example, users at corporate site 1 should connect to a Verizon network and, if there's no Verizon coverage, then connect to an AT&T network. As another example, users at site 2, which is a secure site, should connect to private network to increase security. That is, corporate IT departments want to be the “owners” of this selection; they want to assign just specific SIM profiles (usually from different network providers or from their own private networks) and decide which one shall be used. But, in the current state of the art, it is not feasible for the IT department to manually select a profile for thousands of users, or it may be the case that the communication device is not reachable for lack of coverage, thereby making it impossible for the IT department to remotely configure the device.

Accordingly, in one aspect there is provided a method performed by a communication device comprising a secure element storing a set of available profiles. The set of available profiles comprises a first profile and a second profile. The method includes obtaining a profile policy. The method also includes, based on the profile policy, determining a preferred profile from among the available profiles, wherein the preferred profile identifies a preferred network. The method also includes after determining the preferred profile, determining whether the preferred network is available. The method further includes, i) after determining that the preferred network is available, enabling the preferred profile or ii) after determining that the preferred network is not available, disabling the preferred profile.

In another aspect there is provided a computer program comprising instructions which when executed by processing circuitry of a communication device causes the communication device to perform any of the methods disclosed herein. In one embodiment, there is provided a carrier containing the computer program wherein the carrier is one of an electronic signal, an optical signal, a radio signal, and a computer readable storage medium. In another aspect there is provided a communication device that is configured to perform the methods disclosed herein. The communication device may include memory and processing circuitry coupled to the memory.

An advantage of the embodiments disclosed herein is that they provide an efficient and intelligent way for a communicate device to automatically select the best profile. For example, as network conditions change, the communication device can detect this and, in response, automatically enable a profile for a network that provides a better service. This can decrease latency as well as increase the battery life of the device as the device may not need to use as much power to communicate with the network that provides the better service.

### BRIEF DESCRIPTION OF THE DRAWINGS

The accompanying drawings, which are incorporated herein and form part of the specification, illustrate various embodiments.

FIG. 1 illustrates a conventional system for enabling a communication device to obtain and store multiple SIM profiles.

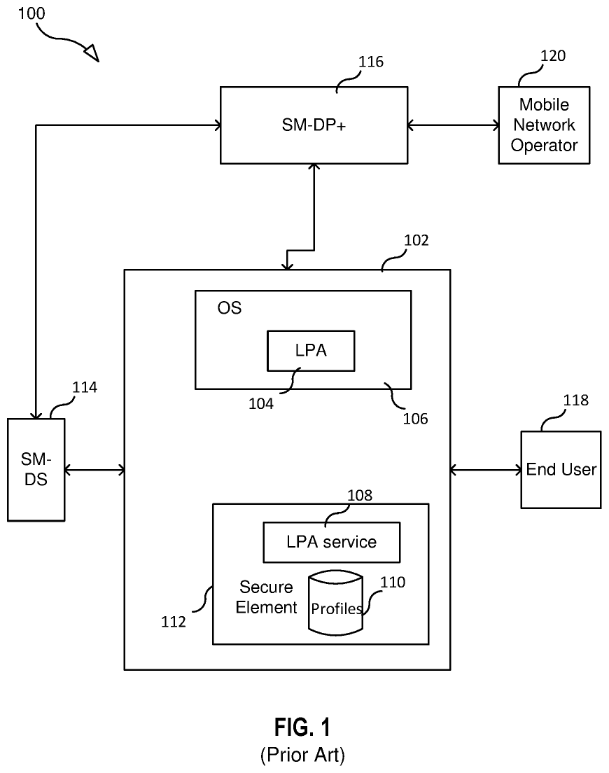

FIG. 2 illustrates a system for enabling a new communication device to obtain and implement a profile policy.

FIG. 3 is a flow chart illustrating a process, according to an embodiment, for automatically selecting a profile based on a profile policy.

FIG. 4A illustrates a diagram according to an embodiment in which the preferred profile from the profile policy and the active profile being used by the communication device are the same.

FIG. 4B illustrates a diagram according to an embodiment in which the preferred profile from the profile policy and the active profile being used by the communication device are not the same.

FIG. 5 is a flowchart illustrating a process for implementing a profile policy according to an embodiment.

FIG. 6 is a block diagram of a communication device according to an embodiment.

### DETAILED DESCRIPTION

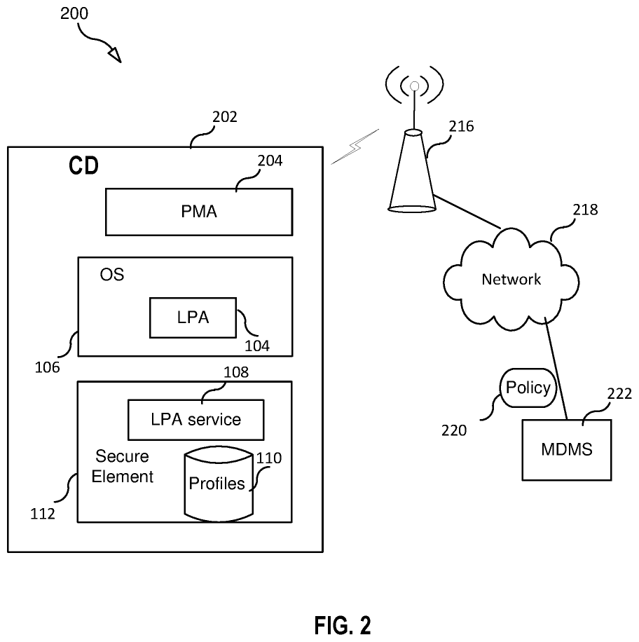

FIG. 2 illustrates a system 200 including a communication device (CD) 202 configured to wirelessly communicate with an access point 216 (e.g., a base station of a radio access network (RAN), a WiFi router, etc.) and to obtain and implement a profile policy 220.

Communication device 202 differs from conventional communication device 102 in that communication device 202 has a profile management application (PMA) 204 (a.k.a., “Net-Tune”). In the embodiment shown, PMA 204 is configured to use LPA 104's north-bound interface to interact with LPA 104 to implement profile selection based on the profile policy 220. In some embodiments, the PMA 204 runs on top of operating system (OS) 106 (i.e., in some embodiments, PMA is not a component of OS 106). For example, in some embodiments, a user of device 202 (or an IT administrator) loads PMA 204 onto device 202. In some embodiments, PMA 204 can be a component of LPA 104 or a component of OS 106. In some embodiments, the LPA is a component of the OS of the secure element 112 (e.g., LPA 104 may be a component of LPA service 108) and it is also possible that the PMA is a component of the OS of the secure element 112 (e.g., the PMA may also be a component of LPA service 108).

An MDM system (MDMS) 222 is operable to provide profile policy 220 (or “policy” for short) to communication device 202 via a network 218 (e.g., the internet or a private data network). MDMS 222 can push the policy to communication device 202 or communication device 202 can pull the policy from MDMS 222 (e.g., device 202 may send a Get policy request to MDMS 222, which then respond by sending a policy to device 220) In some embodiments, profile policy 220 includes a list of profiles, and, for each profile in the list, priority information indicating a priority assigned to the profile (e.g., the priority information may be a priority value specifying a priority). In some embodiments, the profile policy 220 may include a most preferred profile that is more preferred than any other profile within the profile policy 220 (if there are any).

PMA 204 is operable to request LPA 104 to provide to PMA 204 a list of available profiles. In one embodiment, the available profiles are the profiles that are stored in storage unit 110. The LPA 104 may obtain the list of available profiles from LPA service 108. The LPA 104 may push the list of available profiles to PMA 204 and/or LPA 104 may be configured to provide the list on-demand (i.e., in response to getting a list request from PMA 2024). The list of available profiles may include an active profile indicator indicating which one of the profiles in the list is an active profile (i.e., a profile currently being used by the communication device 202). In another embodiment, the active profile indicator can be retrieved by the PMA from the LPA via a specific interface provided by the LPA.

In one embodiment, PMA 204 uses the profile policy and the active profile indicator to determine whether the active profile is the most preferred profile. If the active profile is the most preferred profile, then PMA 204 monitors the quality of the network identified by the active profile to determine whether the network is “available” (i.e., to determine whether the quality of the network exceeds a threshold). If the network is available, then PMA 204 simply continues to monitor the network. If the network become unavailable, then PMA 204 may disable the currently active profile and use information from the profile policy to select a different available profile and then enable that selected profile so that the selected profile becomes the active profile. The selecting of a different available profile is preferably based on the priorities assigned to the available profiles.

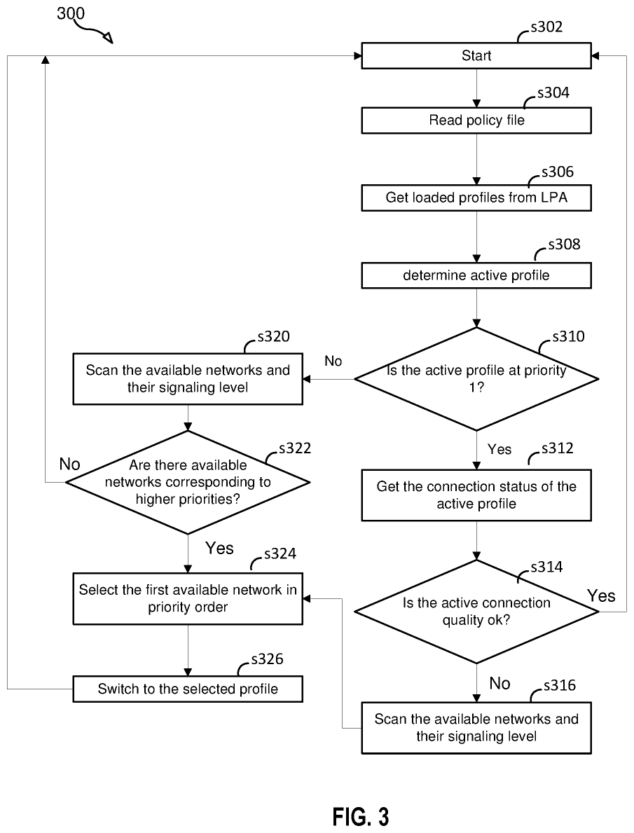

FIG. 3 is a flow chart illustrating a process 300, according to an embodiment, for automatically selecting a profile based on a profile policy. Process 300 may begin at step s302. Step s302 comprises activating PMA 204.

PMA 204 may be activated remotely. In some embodiments, PMA is activated by MDMS 222. In some embodiments, upon activation, PMA pulls a profile policy from MDMS. In other embodiments, PMA will receive the preferred policy along with the activation message. In yet other embodiments, the profile policy may already be stored within the communication device.

At step s304, the PMA reads the profile policy PMA.

At step s306, the PMA obtains the list of available profiles. In some embodiments, the list of available profiles may be obtained from the LPA.

At step s308, the PMA determines which one of the available profiles is the active profile.

At step s310 the PMA determines, based on the profile policy, whether the active profile is the most preferred profile (i.e., the profile among all the available profiles that is assigned the highest priority). If the active profile is not the most preferred profile, then the process proceeds to step s320, otherwise the process proceeds to step s314.

At step s314, the network connection of the network associated with the active profile maybe tested to determine whether the network is available.

In some embodiments, the network is deemed available if the signal quality of the network is greater than or not less than a signal quality threshold. In other embodiments, a multiple network connection quality test may require multiple iterations in order for the network to be available. For example, the network connection quality may have to measure as greater than or equal to a threshold for five consecutive tests in order for a network to be considered available. If the network is considered available, the PMA may designate the active profile to continue to be used by the communication device.

If the network is determined not to be available, the process will move to step s316. At step s316, the PMA may request for other available networks to be scanned to determine if they are available. In some embodiments, the order in which the other available networks are scanned may be based off the profile policy. For example, the profile policy may have a profile that is second in priority. A second network associated with the second profile may then be scanned to determine if the network is available. Next, a third network corresponding to a third profile that is third in priority would be scanned. In another embodiment, PMA scans for all supported frequencies to determine all of networks from which a signal can be received.

At step s324, the PMA may then pick the available network whose corresponding profile has the highest priority. For example, the PMA may pick a second network that corresponds to a second profile that is second in priority if the second network is among the networks that are available.

At step s326, the PMA may message the LPA to switch to the profile that corresponds to the selected network. The LPA may then set the selected profile as active profile of the communication device.

At step s320, as in step s316, other networks are scanned to determine if they are available.

At step s322, the PMA determines whether any of the networks determined to be available correspond to any preferred profiles listed in the profile policy. If no networks corresponding to preferred profiles within the profile policy are available, the PMA may designate the active profile to continue to be used by the communication device.

If at least one available network does correspond to a preferred profile listed in the profile policy, then the process will continue to step s324 and step s326. Steps s324 and 326 may be implemented in the same manner as discussed above.

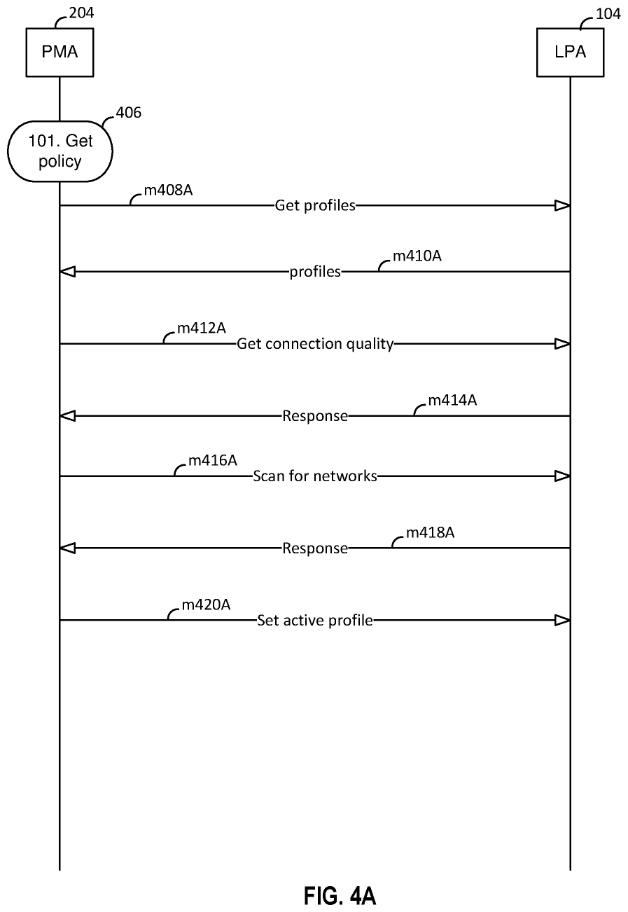

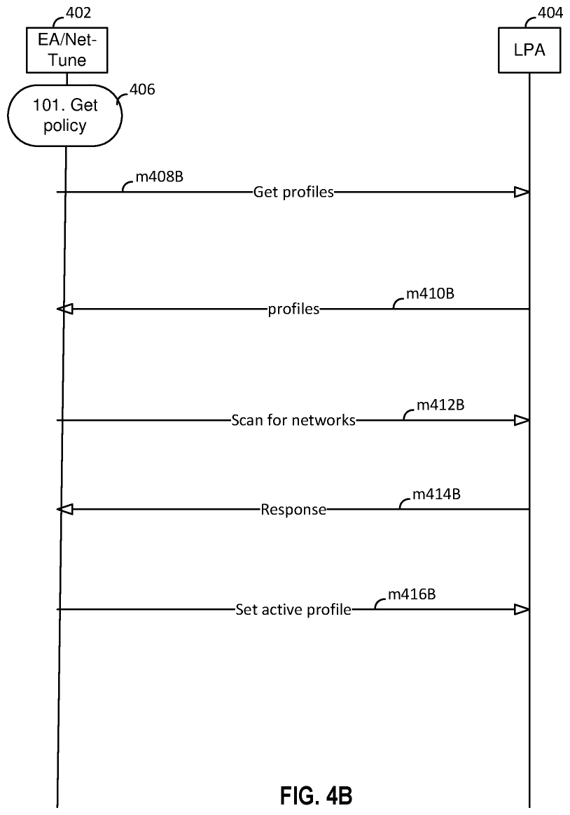

FIG. 4A is a signaling diagram illustrating an embodiment in which the active profile is the most preferred profile.

At step 406, PMA may receive a policy profile A. The policy profile A may be provided by MDMS 222. The profile policy A may include a list of profiles that are given different priority levels. In some embodiments, the profile policy A may include a preferred profile A that is more preferred than any other profile within the profile policy A (if there are any).

At m408A, PMA may send a request to the LPA for the available profiles that are currently stored within the communication device.

At m410A, the LPA may send a response containing the available profiles. In some embodiments, the response may include a designation of an active profile, wherein the active profile is the profile currently being used by the communication device. PMA may determine that the active profile and the preferred profile A are the same. In another embodiment, PMA invoke a specific interface of the LPA to trigger the LPA to return the active profile indicator.

At m412A, PMA may send a message to the LPA requesting the connection quality for the network corresponding to the active profile (which may involve determining whether the network is available). A network may be determined to be available when the connection quality of the network is greater than or not less than a threshold.

At m414A, the LPA may send a response message. In some embodiments, the response message may designate that the network associated with the active profile is available. In such instances, the active profile may remain the profile being used by the communication device.

In other embodiments, the response message may designate that the network associated with the active profile is not available. In such instances, PMA will move to m416A.

At m416A, PMA may send a request message to the LPA to scan for other networks to determine their availability. The requested other networks may correspond the profiles within the profile policy A. In some embodiments, the request for network availability may only include networks that are both within the profiles listed in the profile policy A and available profiles supplied at m410A.

At m418A, the LPA may send a response message. The response message contains a list of networks that are available.

If no other networks are available, PMA may return to m408A. In other embodiments, PMA may return to be being idle.

If other networks are available, PMA may select the available network corresponding to the profile that has the highest priority within the profile policy A.

At m420A, PMA may send a message to the LPA to select the highest priority profile within the profile policy A that has an available network.

FIG. 4B is a signaling diagram illustrating an embodiment in which the active profile is not the most preferred profile.

At 406, PMA may receive a profile policy B that contains a preferred profile B that is the most preferred profile of profile policy B. The preferred profile B may differ from the preferred profile A in FIG. 4A.

The enhancement application may send the same profile request at m408b as m408a in FIG. 4A.

The message sent by the LPA at m410b may be similar to that sent at m410a in FIG. 4A. But at m410b, PMA may determine that the active profile used by the communication device and the preferred profile B are not the same.

At m412b, PMA may send a request message to the LPA to scan for other networks to determine their availability. The requested other networks may correspond the profiles within the profile policy. In some embodiments, the request for network availability may only include networks that are both within the profiles listed in the profile policy B and available profiles supplied at m410B.

At m414B PMA may send a response message. The response message contains a list of networks that can be detected, and, for each detected network, information on the quality of the network (e.g., signal power) so that the PMA can determine whether the network has good enough quality (i.e., whether the network is “available”).

If no other networks are available, PMA may return to m408A. In other embodiments, PMA may return to be being idle.

If other networks are available, PMA may select the available network corresponding to the profile that has the highest priority with the profile policy B.

At m420A, PMA may send a message to the LPA to select the highest priority profile within the profile policy B that has an available network.

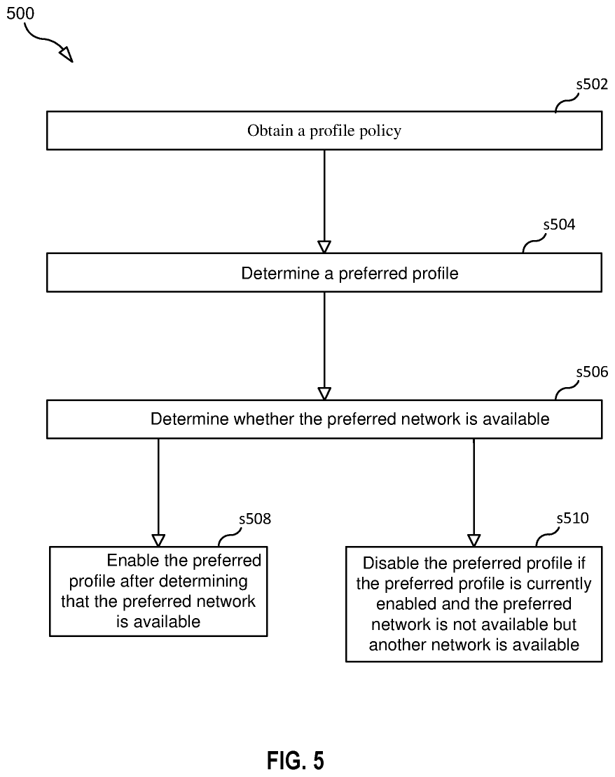

FIG. 5 is a flowchart illustrating a process 500 performed by communication device 202, which as noted above, comprise a secure element 112 (e.g., an eUICC or other tamper proof element) storing a set of available profiles (e.g., a set of two or more SIM profiles), the set of available profiles comprising a first profile and a second profile. Process 500 may begin with step s502.

Step s502 comprises PMA 220 obtaining a profile policy. The profile policy may identify a set of one or more profiles and may further indicate, for each identified profile, a priority assigned to the profile. Accordingly, one profile within the profile policy may be designated as the most preferred profile (e.g., the profile assigned a priority value of 1).

In some embodiments, PMA 220 may take into consideration its current geographic location when obtaining a policy in step s502. For example, communication device 202 may store a number of profiles, where each profile is associated with a different geographic region. Accordingly, in some embodiments, in step s502 the PMA first determines its current geographic region and then selects the profile that is associated with the current geographic region. Hence, in some embodiments, MDMS 222 pushes several profile policies to PMA 202, where each one of the several profile policies is associated with a different geographic region. In one embodiment, if the PMA is not able to determine its location, it can just select a default policy or assume that its location has not changed since the last time its location was determined.

Step s504 comprises, based on the profile policy, determining a preferred profile from among the available profiles, wherein the preferred profile identifies a preferred network.

Step s506 comprises, after determining the preferred profile, determining whether the preferred network is available (e.g., the network is available so long as the quality of the preferred network is greater than threshold or not less than a threshold).

Step s508 comprises enabling the preferred profile after determining that the preferred network is available. In some embodiments, before enabling the preferred profile, the PMA determines whether the communication device has an active session that is internet dependent (e.g., a session that would be terminated automatically if the communication device's IP address were to change). If the communication device has such an active session, the PMA may wait until after the session has ended before enabling the preferred profile. For example, the PMA may determine that the preferred network is available and that the preferred profile is not enabled, but that the communication device is currently streaming or downloading a video or uploading a video. The PMA may recognize that the communication device is streaming video and wait until after the communication device is done streaming the video to switch to the preferred profile (assuming the network is still available at that time). That is, when the data traffic has stopped, the PMA will check whether the preferred network is available, and, if it is, switch to the preferred profile.

Step s510 comprises, after determining that the preferred network is not available, disabling the preferred profile. For instance, in one embodiment, the preferred profile is disabled if the preferred network is not available and the preferred profile is currently enabled (assuming another network is available). In some embodiments, before disabling the preferred profile, the PMA determines whether the communication device has an active session that is internet dependent. If the communication device has such an active session, the PMA may wait until after the session is complete before disabling the preferred profile (assuming that the preferred network is not available at that time).

In one example, a corporation may have a MDM system comprising a plurality of communication devices. The corporation may prefer that the communication devices connect to profile A corresponding to a network A. If profile A is not available, however, the corporation may prefer that user devices connect to profile B corresponding to a network B. These preferences may be put into a profile policy, wherein profile A is the most preferred profile and profile B is the second most preferred profile.

The MDM operator may transfer the profile policy to one or more communication devices connected to the MDM system. The PMA within a communication device may receive the policy profile and determine that profile A is the most preferred profile. The PMA may next determine whether network A is available. The device may determine whether network A is available by determining that its network connection strength is above or equal to a threshold.

If network A is available, then the PMA may next determine whether profile is currently being used by the device. If the profile A is currently being used by the device then profile A may remain as the active profile. If profile A is not currently the active profile then the PMA may select profile A to be the active profile of the device.

If the network determines that network A is not available then the PMA may determine whether profile A is the active profile currently being used by the device. If profile A is the current profile being actively used by the device then the PMA may switch to a different profile such as profile B.

In some embodiments, the communication device will first check if the network corresponding to profile B is available before switching to profile B. In other embodiments, the active profile of the communication device may remain the same.

If profile A is not the active profile of the device and the network A is not available, then the PMA may not switch the active profile. In other embodiments, the communication device may switch the active profile to be profile B if it determines that the network corresponding with profile B is available.

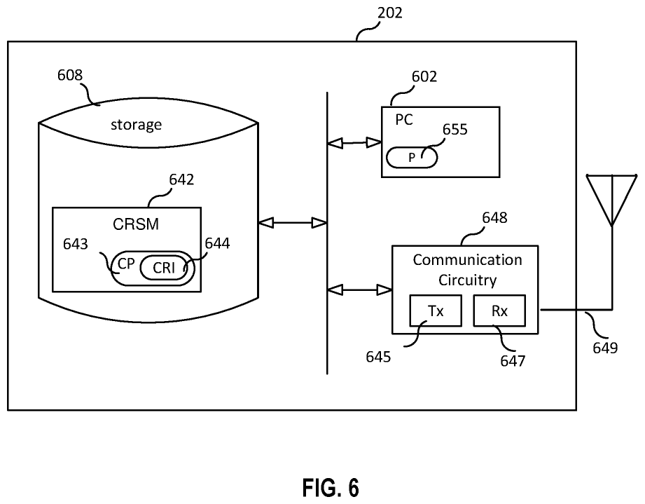

FIG. 6 is a block diagram of communication device (CD) 202, according to some embodiments. As shown in FIG. 6, CD 202 may comprise: processing circuitry (PC) 602, which may include one or more processors (P) 655 (e.g., one or more general purpose microprocessors and/or one or more other processors, such as an application specific integrated circuit (ASIC), field-programmable gate arrays (FPGAs), and the like); communication circuitry 648, which is coupled to an antenna arrangement 649 comprising one or more antennas and which comprises a transmitter (Tx) 645 and a receiver (Rx) 647 for enabling CD 202 to transmit data and receive data (e.g., wirelessly transmit/receive data); and a storage unit (a.k.a., “data storage system”) 608, which may include one or more non-volatile storage devices and/or one or more volatile storage devices. In embodiments where PC 602 includes a programmable processor, a computer readable storage medium (CRSM) 642 may be provided. CRSM 642 may store a computer program (CP) 643 comprising computer readable instructions (CRI) 644. CRSM 642 may be a non-transitory computer readable medium, such as, magnetic media (e.g., a hard disk), optical media, memory devices (e.g., random access memory, flash memory), and the like. In some embodiments, the CRI 644 of computer program 643 is configured such that when executed by PC 602, the CRI causes CD 202 to perform steps described herein (e.g., steps described herein with reference to the flow charts). In other embodiments, CD 202 may be configured to perform steps described herein without the need for code. That is, for example, PC 602 may consist merely of one or more ASICs. Hence, the features of the embodiments described herein may be implemented in hardware and/or software.

### Summary of Various Embodiment

A1. A method performed by a communication device (e.g. CD 202) comprising a secure element (e.g., an eUICC or other tamper proof element) storing a set of available profiles (e.g., a set of two or more SIM profiles), the set of available profiles comprising a first profile and a second profile, the method comprising: obtaining a profile policy; based on the profile policy, determining a preferred profile from among the available profiles, wherein the preferred profile identifies a preferred network; after determining the preferred profile, determining whether the preferred network is available (e.g., the network is available so long as the quality of the preferred network is greater than threshold or not less than a threshold); and i) after determining that the preferred network is available, enabling the preferred profile; or ii) if the preferred network is not available and another network is available and the preferred profile is currently enabled, then disabling the preferred profile.
A2. The method of embodiment A1, wherein determining the preferred profile comprises: based on the profile policy, determining, for each profile included in the set of available profiles, a priority of the available profile, wherein the preferred profile is a profile from the set of available profiles that has the highest priority.
A3. The method of embodiment A2, wherein the profile policy identifies a second set of one or more profiles, for each profile included in the second set of profiles, the profile policy indicates a priority of the profile, and the second set of profiles includes at least one profile that is also included in the set of available profiles.
A4. The method of embodiment A2 or A3, wherein the communication device comprises an operating system, the communication device comprises an LPA running within the operating system, and the method further comprises, prior to determining the preferred profile: sending a request to the LPA for a list of the profiles included in the set of available profiles; and receiving the list of available profiles from the LPA.
A5. The method of any one of embodiments A1-A4, wherein determining that the preferred network is available, comprises: determining a quality of the preferred network based on one or more measurements of one or more signals transmitted by a radio access network (RAN) node belonging to the preferred network; and determining whether the determined quality excee'ds a quality threshold.
A6. The method of any one of embodiments A1-A5, wherein the preferred policy is not currently enabled, the preferred network is determined to be available, and the method comprises enabling the preferred profile as a result of determining that the preferred network is available and the preferred policy is not currently enabled.
A7. The method of any one of embodiments A1-A5, wherein the preferred policy is currently enabled, the preferred network is determined to be unavailable (e.g., quality of the preferred network is below a quality threshold), and the method comprises, as a result of determining that the preferred network is unavailable and the preferred policy is currently enabled, disabling the preferred profile and enabling another profile included in the first set of profiles.
A8. The method of any one of embodiments A1-A5, wherein the preferred policy is currently enabled, the preferred network is determined to be not available, a second network is determined to be available, and the method comprises, as a result of determining that the preferred network is not available, the second network is available, and the preferred policy is currently enabled, disabling the preferred profile and enabling a profile associated with the second network.
A9. The method of any one of embodiments A1-A8, wherein obtaining the profile policy comprises: determining a geographic location of the communication device; and selecting the profile policy based on the determined geographic location.
A10. The method of embodiment A1, A7, or A8, further comprising: before disabling the preferred profile, determining that the communication device has an active session that is internet dependent; and waiting until after the active session is complete before disabling the preferred profile.
B1. A computer program (643) comprising instructions (644) which when executed by processing circuitry (602) of a communication device (202) causes the communication device to perform the method of any one of embodiments A1-A8.
B2. A carrier containing the computer program of embodiment B1, wherein the carrier is one of an electronic signal, an optical signal, a radio signal, and a computer readable storage medium (642).
C1. A communication device (202), the communication device being configured to perform the method of any one of embodiments A1-A8.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

As used herein transmitting a message “to” or “toward” an intended recipient encompasses transmitting the message directly to the intended recipient or transmitting the message indirectly to the intended recipient (i.e., one or more other nodes are used to relay the message from the source node to the intended recipient). Likewise, as used herein receiving a message “from” a sender encompasses receiving the message directly from the sender or indirectly from the sender (i.e., one or more nodes are used to relay the message from the sender to the receiving node). Further, as used herein “a” means “at least one” or “one or more.”

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method performed by a communication device comprising a secure element storing a set of available profiles, the set of available profiles comprising a first profile and a second profile, the method comprising:
obtaining a profile policy;
based on the profile policy, determining a preferred profile from among the available profiles, wherein the preferred profile identifies a preferred network;
after determining the preferred profile, determining whether the preferred network is available; and
i) after determining that the preferred network is available, enabling the preferred profile; or
ii) after determining that the preferred network is not available, disabling the preferred profile.

2. The method of claim 1, wherein determining the preferred profile comprises:
based on the profile policy, determining, for each profile included in the set of available profiles, a priority of the available profile, wherein
the preferred profile is a profile from the set of available profiles that has the highest priority.

3. The method of claim 2, wherein
the profile policy identifies a second set of one or more profiles,
for each profile included in the second set of profiles, the profile policy indicates a priority of the profile, and
the second set of profiles includes at least one profile that is also included in the set of available profiles.

4. The method of claim 2, wherein
the communication device comprises an operating system,
the communication device comprises a local profile assistant, (LPA) running within the operating system, and
the method further comprises, prior to determining the preferred profile:
sending a request to the LPA for a list of the profiles included in the set of available profiles; and
receiving the list of available profiles from the LPA.

5. The method of claim 1, wherein determining that the preferred network is available, comprises:
determining a quality of the preferred network based on one or more measurements of one or more signals transmitted by a radio access network, (RAN) node belonging to the preferred network; and
determining whether the determined quality exceeds a quality threshold.

6. The method of claim 1, wherein
the preferred policy is not currently enabled,
the preferred network is determined to be available, and
the method comprises enabling the preferred profile as a result of determining that the preferred network is available and the preferred policy is not currently enabled.

7. The method of claim 1, wherein
the preferred policy is currently enabled,
the preferred network is determined to be not available, and
the method comprises, as a result of determining that the preferred network is not available and the preferred policy is currently enabled, disabling the preferred profile and enabling another profile included in the first set of profiles.

8. The method of claim 1, wherein
the preferred policy is currently enabled,
the preferred network is determined to be not available,
a second network is determined to be available, and
the method comprises, as a result of determining that the preferred network is not available, the second network is available, and the preferred policy is currently enabled, disabling the preferred profile and enabling a profile associated with the second network.

9. The method of claim 1, wherein obtaining the profile policy comprises:
determining a geographic location of the communication device; and
selecting the profile policy based on the determined geographic location.

10. The method of claim 1, further comprising:
before disabling the preferred profile, determining that the communication device has an active session that is internet dependent; and
waiting until after the active session is complete before disabling the preferred profile.

11. A communication device the communication device comprising:
processing circuitry; and
a secure element storing a set of available profiles, the set of available profiles comprising a first profile and a second profile, wherein
the communication device is configured to perform a method that comprises:
obtaining a profile policy;
based on the profile policy, determining a preferred profile from among the available profiles, wherein the preferred profile identifies a preferred network;
after determining the preferred profile, determining whether the preferred network is available; and
i) after determining that the preferred network is available, enabling the preferred profile; or
ii) after determining that the preferred network is not available, disabling the preferred profile.

12. The communication device of claim 11, wherein determining the preferred profile comprises:
based on the profile policy, determining, for each profile included in the set of available profiles, a priority of the available profile, wherein
the preferred profile is a profile from the set of available profiles that has the highest priority.

13. The communication device of claim 12, wherein
the profile policy identifies a second set of one or more profiles,
for each profile included in the second set of profiles, the profile policy indicates a priority of the profile, and
the second set of profiles includes at least one profile that is also included in the set of available profiles.

14. The communication device of claim 12, wherein
the communication device comprises an operating system,
the communication device comprises a local profile assistant, (LPA) running within the operating system, and
the method further comprises, prior to determining the preferred profile:
sending a request to the LPA for a list of the profiles included in the set of available profiles; and
receiving the list of available profiles from the LPA.

15. The communication device of claim 11, wherein determining that the preferred network is available, comprises:
determining a quality of the preferred network based on one or more measurements of one or more signals transmitted by a radio access network, (RAN) node belonging to the preferred network; and
determining whether the determined quality exceeds a quality threshold.

16. The communication device of claim 11, wherein
the preferred policy is not currently enabled,
the preferred network is determined to be available, and
the method comprises enabling the preferred profile as a result of determining that the preferred network is available and the preferred policy is not currently enabled.

17. The communication device of claim 11, wherein
the preferred policy is currently enabled,
the preferred network is determined to be unavailable, and
the method comprises, as a result of determining that the preferred network is unavailable and the preferred policy is currently enabled, disabling the preferred profile and enabling another profile included in the first set of profiles.

18. The communication device of claim 11, wherein
the preferred policy is currently enabled,
the preferred network is determined to be unavailable,
a second network is determined to be available, and
the method comprises, as a result of determining that the preferred network is unavailable, the second network is available, and the preferred policy is currently enabled, disabling the preferred profile and enabling a profile associated with the second network.

19. The communication device of claim 11, wherein obtaining the profile policy comprises:
determining a geographic location of the communication device; and
selecting the profile policy based on the determined geographic location.

20. A non-transitory computer readable storage medium storing a computer program comprising instructions which when executed by processing circuitry of a communication device causes the communication device to perform the method of claim 1.

21. (canceled)
